(19) United States
(12) Patent Application Publication
(10) Pub. No.: US 2020/0080587 A1
(43) Pub. Date: Mar. 12, 2020

(54) Forged Steel Cross-Head Piston

(71) Applicants: James L. Campbell, Lawrenceville, GA (US); Navid Yavari, Atlanta, GA (US); Mike Franks, Monroe, GA (US); Jan A. Ruble, Statham, GA (US)

(72) Inventors: James L. Campbell, Lawrenceville, GA (US); Navid Yavari, Atlanta, GA (US); Mike Franks, Monroe, GA (US); Jan A. Ruble, Statham, GA (US)

(73) Assignee: PAI Industries, Inc., Suwanee, GA (US)

(21) Appl. No.: 16/128,640

(22) Filed: Sep. 12, 2018

(51) Int. Cl. F16C 5/00; F16J 1/14

(52) U.S. Cl. CPC F16C 5/00; F02F 3/22; F16J 1/14

(57) ABSTRACT

A piston unit for coupling to a crosshead piston rod with a crosshead piston pin includes a piston crown member and an integrated crosshead pin support and skirt member. The piston crown member consists essentially of forged steel. An integrated crosshead pin support and skirt member consists essentially of forged steel. The integrated pin support and skirt member is affixed to the piston crown member and is configured to support the crosshead piston pin. In a method of making a crosshead piston, a piston crown member is forged from steel. An integrated crosshead pin support and skirt member is forged from steel. The piston crown member is welded to the integrated crosshead pin support and skirt member.

### BACKGROUND OF THE INVENTION

### 1. Field of the Invention

The present invention relates to internal combustion engines and, more specifically, to a cross-head piston for use in diesel engine.

### 2. Description of the Related Art

Internal combustion engines, such as diesel and gasoline engines, are heat engines in which the burning of a fuel occurs in a confined space to create gases of high temperature and pressure. The gasses expand in the engine to do work. Typically, an internal combustion engine includes a cylinder into which fits a piston. The fuel is burned in the space between the cylinder and the piston, driving the piston outwardly when the burning gasses expand. The piston is usually coupled to a connecting rod, which transfers the reciprocating lateral motion of the piston to a crank shaft. The crankshaft translates the lateral motion to rotary motion, which is ultimately applied to perform useful work.

A typical piston includes a piston crown member, which includes a piston head having a diameter corresponding to the diameter of the cylinder into which the piston fits. Two spaced apart connecting ears extend from the piston head and connect the piston head to the connecting rod. Each connecting ear includes a pin bore into which fits a pin to which the connecting rod is coupled.

One type of existing piston is a cross-head piston, in which the connecting rod is bolted to the pin (also referred to as a “cross pin”). The connecting rod includes an elongated oil passage and the cross pin defines a passage therethrough that is in alignment with the oil passage of the connecting rod. In this way, oil passes through the elongated oil passage into an area around the piston, thereby providing lubrication and cooling.

Older cross-head pistons were cast from iron and machined to form surfaces in moving contact with other parts (e.g., the cylinder, the pin, etc.). The pin bore of a typical cross-head piston includes a replaceable bushing. The bushings wear out frequently and are costly to replace. Also, cast iron pistons are subject to fatigue.

Fatigue is a significant problem in cast iron pistons. As trucking companies desire to increase the loads that they carry, they often adjust their engine control systems to increase the horsepower output of their engines. With extended use at higher horsepower, cracks in the piston form which can result in catastrophic dome separation. Dome separation occurs when the piston head breaks away from the rest of the crown portion and usually requires a complete engine overhaul.

Another type of piston is a forged steel piston, which has an advantage over cast iron of being less susceptible to fatigue and can handle higher horsepower settings. However, because of the nature of the forging process, forged pistons cannot distribute oil from the elongated oil passage in the piston rods employed in older engines. Because stagnant oil in such passages would result in other types of failures, when cast iron pistons are replaced with forged steel pistons, the piston rods and piston pins must also be replaced. While replacing a piston is relatively straightforward and inexpensive, replacing a piston rod can be complicated and expensive.

Large commercial vehicles often employ diesel engines that are used for many years. The pistons in such engines are replaced at regular service intervals. Because existing cross-head pistons employ connecting rods that must be bolted to the corresponding cross-pins, forged steel pistons cannot be used as replacement parts in engines employing cross-head pistons without also replacing the connecting rods. Purchasing new connecting rods to replace serviceable connecting rods is costly and wasteful.

Therefore, there is a need for a forged steel piston that is compatible with existing piston rods.

There is also a need for a method of making a cross-head piston from forged steel.

### SUMMARY OF THE INVENTION

The disadvantages of the prior art are overcome by the present invention which, in one aspect, is a piston unit for coupling to a crosshead piston rod with a crosshead piston pin That includes a piston crown member and an integrated crosshead pin support and skirt member. The piston crown member consists essentially of forged steel. The integrated crosshead pin support and skirt member consists essentially of forged steel. The integrated pin support and skirt member is affixed to the piston crown member and is configured to support the crosshead piston pin.

In another aspect, the invention is a crosshead piston including a crosshead piston unit consisting essentially of forged steel.

In yet another aspect, the invention is a method of making a crosshead piston in which a piston crown member is forged from steel. An integrated crosshead pin support and skirt member is forged from steel. The piston crown member is welded to the integrated crosshead pin support and skirt member.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a perspective view of one embodiment of a forged steel crosshead piston.

FIG. 1B is an elevational view of the embodiment shown in FIG. 1A.

FIG. 1C is a cross-sectional view of the embodiment shown in FIG. 1A taken along line 1C-1C.

FIG. 2A is a top plan view of a crown member of the embodiment shown in

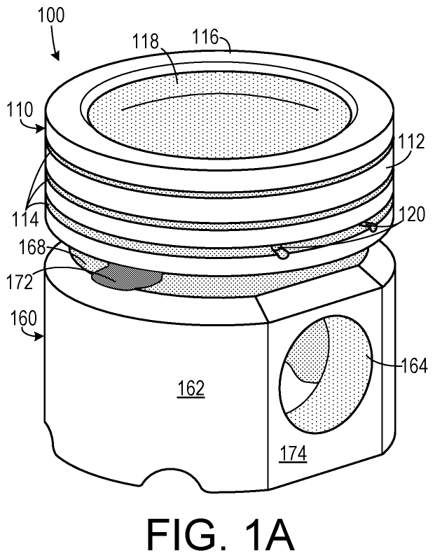

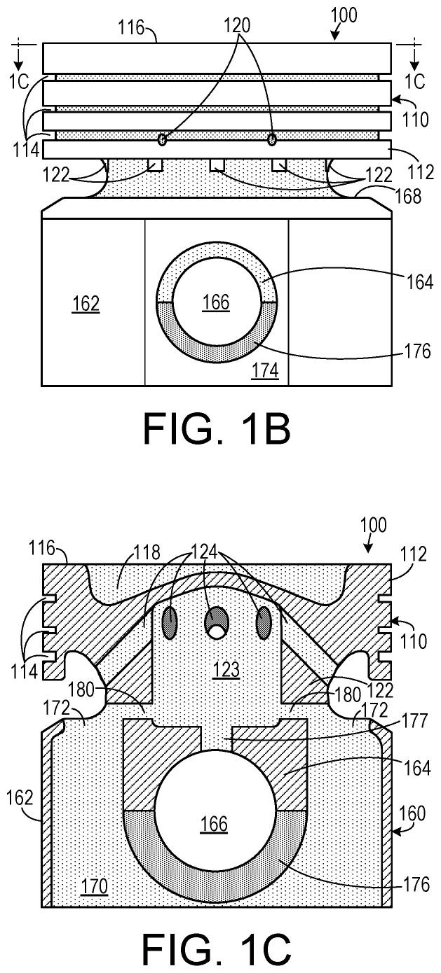

FIG. 1A.

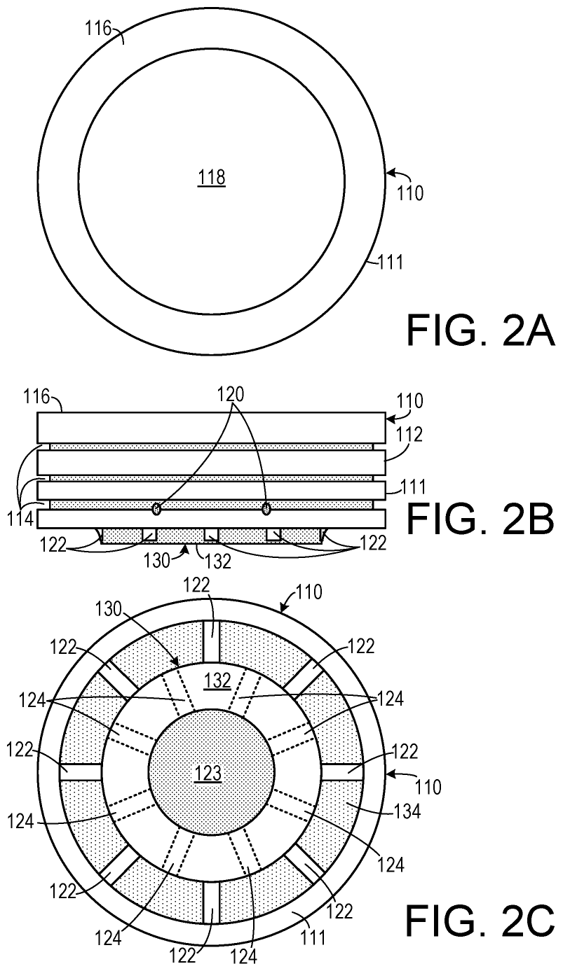

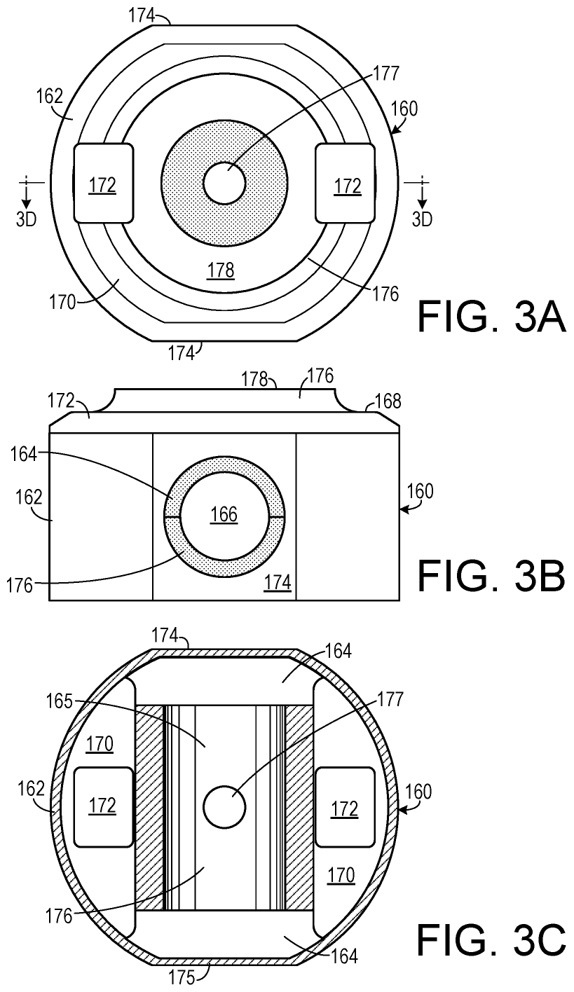

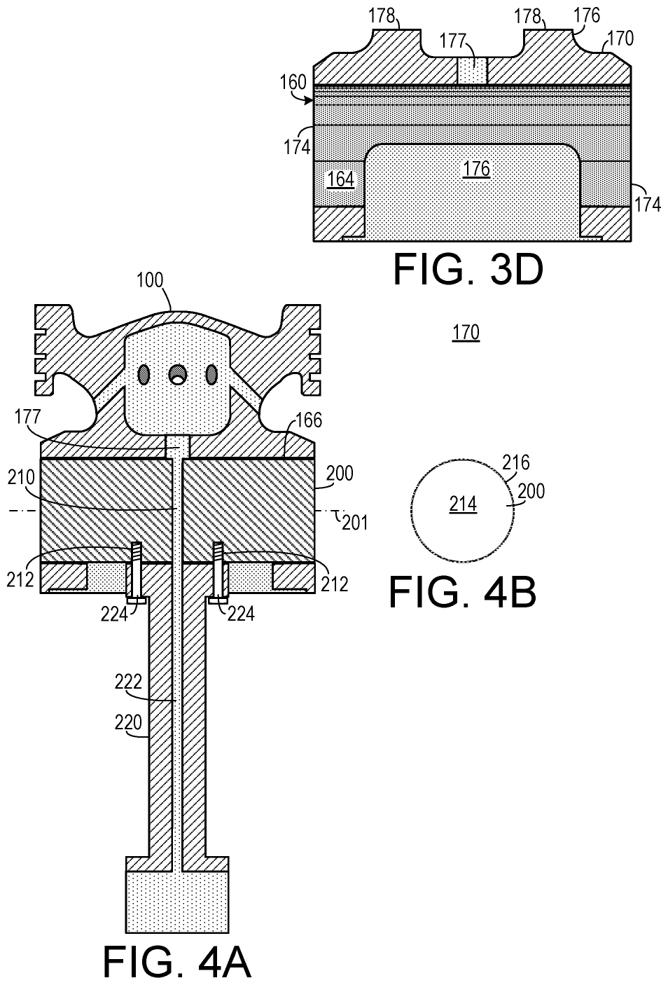

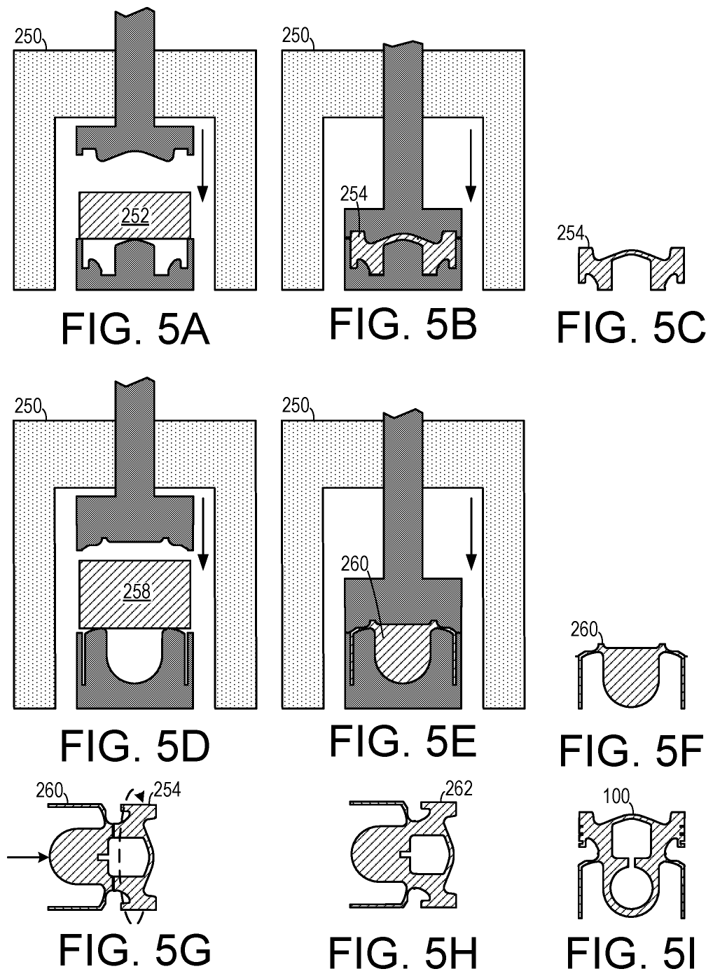

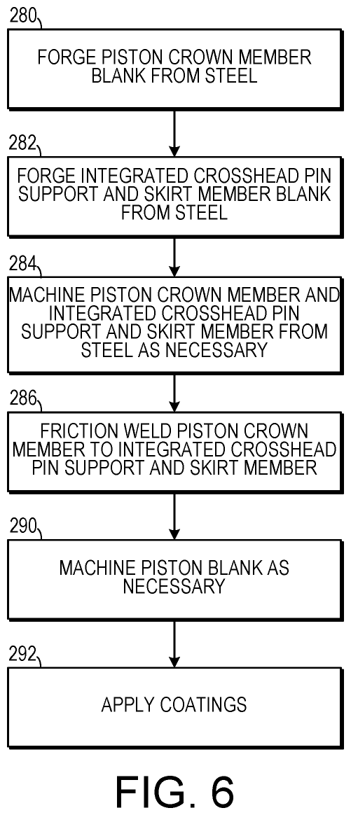

FIG. 2B is an elevational view of the crown member of FIG. 2A.

FIG. 2C is a bottom plan view of the crown member of FIG. 2A.

FIG. 3A is a top plan view of an integrated crosshead pin support and skirt member of the embodiment shown in FIG. 1A.

FIG. 3B is an elevational view of the integrated crosshead pin support and skirt member of FIG. 3A.

FIG. 3C is a bottom plan view of the integrated crosshead pin support and skirt member of FIG. 3A.

FIG. 3D is a cross-sectional view of the integrated crosshead pin support and skirt member of FIG. 3A taken along line 3D-3D.

FIG. 4A is a cross-sectional view of forged steel crosshead piston coupled to a piston rod by a piston pin.

FIG. 4B is a side elevational view of a piston pin.

FIGS. 5A-5I are a series of schematic diagrams demonstrating a method of making a forged steel cross-head piston.

FIG. 6 is a flowchart showing one method of making a piston.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein “diamond-like carbon” (DLC) includes sp³ bonded carbon atoms of crystalline carbon polytype. In one embodiment, DLC includes tetrahedral amorphous carbon sp³ bonded carbon atoms and metastable form of hydrogenated amorphous carbon (a-C:H) containing significant sp³ bonding.

As shown in FIGS. 1A-1C, one embodiment of a piston unit 100 for coupling to a crosshead piston rod with a crosshead piston pin, includes a piston crown member 100 that consists essentially of forged steel that is welded to an integrated crosshead pin support and skirt member 160 that also consists essentially of forged steel.

As shown in greater detail in FIGS. 2A-2C, the piston crown member 110 includes a cylindrical piston ring carrying member 112 that has a vertical wall 111 that defines a plurality of circular grooves 114 for receiving piston rings (not shown) therein. Oil passages 120 can also be drilled in the piston crown member 110 to facilitate oil flow into the ring area. The piston crown member 110 also includes a top portion 116 that has an interior side and an opposite exterior side. The exterior side of the top portion 116 defines a compression bowl 118. An interior cylindrical member 130 extends downwardly from the interior side of the top portion 116 and defines a ring-shaped void 134 between interior cylindrical member 130 and the vertical wall 111. The interior cylindrical member 130 terminates in a first mating surface 132. A plurality of evenly spaced-apart struts 122 extend radially from the interior cylindrical member 130 to the vertical wall 111. Each of the plurality of struts 122 is integral with the cylindrical member 130, the vertical wall 111 and the top portion 116.

The interior cylindrical member 130 defines a cooling cavity 123 therein. The interior cylindrical member 130 also defines a plurality of oil jet openings 124 passing therethrough so that the cooling cavity 123 is in fluid communication with the ring-shaped void 134. Each of the oil jet openings 124 is disposed between two different ones of the struts 122.

As shown in greater detail in FIGS. 3A-3D, the integrated crosshead pin support and skirt member 160 includes a disc-shaped top member 168 having a top side and an opposite bottom side. A cylindrical mating member 176 extends upwardly from the top side of the top member 168 and terminates in a second mating surface 178. The second mating surface 178 has a shape that corresponds to the first mating surface 132 (as shown in FIG. 2B) so that the first mating surface 132 and the second mating surface 178 are contiguous. A vertical skirt wall 162 extends downwardly from the top member 168. The skirt wall 162 has a first side and a second side opposite from the first side. The vertical skirt wall 162 and the bottom side of the top member 168 defines a void region 170 opening to a bottom region of the vertical skirt wall 162. The top member 168 can define oil passages 172 to facilitate oil flow from the cooling cavity 123 through the oil jets 124, around the struts 122 and back into the void region 170. The vertical skirt wall 162 acts as a skirt that aids in the alignment of the piston 100 within the cylinder and that helps direct oil flow.

A pin support frame 164 is disposed within the void region 170 and extends downwardly from the bottom side of the top member 168. The pin support frame 164 extends from a first side 174 of the vertical skirt wall 162 to a second side 175 of the vertical skirt wall 162. The pin support frame 164 defines a cylindrical pin bore 166 concentric therewith and opens to the first side 174 of the vertical skirt wall 162 and the second side 175 of the vertical skirt wall 168. The pin support frame 164 also defines a rod connection opening 176 between the pin support bore 166 and the void region 170.

The first mating surface 132 of the crown member 110 is welded to the second mating surface 178 of the integrated crosshead pin support and skirt member 160. The first mating surface 132 may be friction welded to the second mating surface 178. (In alternate embodiments, other welding techniques known to the art, such as laser welding, chemical welding, etc., may be used.)

Returning to FIGS. 1A-1C, the disc-shaped top member 168 of the integrated crosshead pin support and skirt member 160 further defines a central pin oil supply passage 177 passing through the top member 168 so that the cooling cavity 123 is in fluid communication with the void region 170 of the integrated crosshead pin support and skirt member 160.

As shown in FIG. 4A, in use a crosshead piston pin 200 is placed within the pin bore 166, the crosshead piston pin 200 has a cylindrical axis 201 and the crosshead piston pin 200 defines an oil passage 210 passing orthogonally to the cylindrical axis 201. The crosshead piston pin 200 also defines two spaced-apart threaded holes 212, wherein each receive therein a piston rod coupling bolt 224 for coupling a piston rod 220 to the piston pin 200. The oil passage 210 is contiguous with an oil passage 222 in the piston rod 220 and is aligned with the oil supply passage 177. As shown in FIG. 4B, the crosshead piston pin 200 includes a steel core 214 and an outer surface to which a diamond-like carbon coating 216 may be affixed to a portion thereof (Diamond like carbon coating confers mechanical hardness, low friction, optical transparency and chemical inertness. One source for diamond like carbon coatings is Calico Coatings of 5883 Balsom Ridge Road, Denver, N.C. 28037.) Because the piston 100 is made from forged steel, it is harder than cast iron pistons and the bearing surface 165 of the pin support frame 164 will not wear appreciably due to contact with the steel piston pin 200. Therefore, sacrificial bushings are not required with the present invention.

As shown in FIGS. 5A-5I, manufacturing a piston of the type described above involves using a forge 250 to form a piece of steel 252 into a crown member blank 254 (as shown in FIGS. 5A-5C) and another piece of steel 258 into an integrated crosshead pin support and skirt member blank 260. The blanks 254 and 260 are machined as necessary. (For example, the oil jet openings 124 can be drilled into the crown member blank 254 prior to welding the two blanks together. Additional oil passages can also be drilled or cut in the blanks at this stage.) Once preliminary machining is complete, the blanks 254 and 260 are welded together. In one embodiment, they are friction welded by rotating one blank (e.g., blank 254) relative to the other blank (e.g., blank 260) while applying inward force to one of the blanks. The resulting friction between the mating surfaces causes surface melting of the steel. Some of the melted steel is pushed out radially, taking any surface impurities with it. Once the surfaces are sufficiently melted, the rotation stops and the resulting piston unit blank 262 is cooled, thereby affixing the weld. The piston unit blank 262 is machined (e.g., for such purposes as boring the cylindrical pin bore 166 and lathing the ring grooves 114, etc.) so as to generate the final piston unit 100.

As shown in FIG. 6, in one method of making a piston, the following steps are employed: A piston crown member blank is forged from steel 280; an integrated crosshead pin support and skirt member blank is forged from steel 282; the piston crown member blank and the integrated crosshead pin support and skirt member blank are machined as necessary 284; the piston crown member blank and the integrated crosshead pin support and skirt member blank are friction welded to each other 286; the resulting piston blank is machined as necessary 290; and any necessary coatings are applied to the resulting piston 292. (For example, a magnesium phosphate coating may be applied to portions of the piston to help the piston/cylinder contact surfaces to better retain lubrication during a break-in period.)

There are several advantages over existing crosshead pistons and forged steel pistons resulting from the present invention. For example, the present invention provides the strength of a forged steel piston while allowing it to be retrofitted with an existing crosshead piston rod and an existing crosshead pin. The invention can include such beneficial items as a cooling cavity within the piston (which can be molded in cast iron crosshead pistons, but which cannot be forged into conventional forged steel pistons). The invention eliminates the need for pin bushings required in existing cast iron crosshead pistons. The invention, when retrofit into older engines employing crosshead pistons, can allow the engines to operation at a substantially higher horsepower (e.g., 550 hp vs 350 hp) without a substantial increased probability of piston failure. The pin support frame of the invention is broader than the pin support ears of conventional forged steel pistons, which increases support for the pin and eliminates pin bending moment that can increase wear. The invention increases oil cooling of the piston over that of conventional forged steel pistons. The elimination of pin bushings in the invention strengthens the crosshead piston and reduces its cost. The use of steel in all of the piston parts (including an integrated steel piston skirt, instead of a separate aluminum skirt used in many existing pistons) ensures expansion and contraction at a constant rate among the different components of the piston, thereby reducing wear and increasing efficiency. Also, the invention is lighter and more efficient than conventional crosshead pistons.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A piston unit for coupling to a crosshead piston rod with a crosshead piston pin, the piston comprising:
(a) a piston crown member consisting essentially of forged steel; and
(b) an integrated crosshead pin support and skirt member consisting essentially of forged steel, the integrated pin support and skirt member affixed to the piston crown member and configured to support the crosshead piston pin.

2. The piston unit of claim 1, wherein the piston crown member comprises:
(a) a cylindrical piston ring carrying member, including an exterior vertical wall and a top portion, the top portion having an interior side and an opposite exterior side;
(b) a compression bowl defined by the exterior side of the top portion;
(c) an interior cylindrical member extending downwardly from the interior side of the top portion and defining a ring-shaped void between interior cylindrical member and the vertical wall, the interior cylindrical member terminating in a first mating surface; and
(d) a plurality of evenly spaced-apart struts extending radially from the interior cylindrical member and the vertical wall, the plurality of struts integral with the cylindrical member, the exterior wall and the top portion.

3. The piston unit of claim 2, wherein the integrated crosshead pin support and skirt member comprises:
(a) a disc-shaped top member having a top side and an opposite bottom side;
(b) a cylindrical mating member extending upwardly from the top side of the top member and terminating in a second mating surface, the second mating surface having a shape that corresponds to the first mating surface so that the first mating surface and the second mating surface are substantially contiguous;
(c) a vertical skirt wall extending downwardly from the top member, the skirt wall having a first side and a second side opposite from the first side, the vertical skirt wall and the bottom side of the top member defining a void region opening to a bottom region of the vertical skirt wall;
(d) a pin support frame disposed within the void region and extending downwardly from the bottom side of the top member, the pin support frame extending from a first side of the vertical skirt wall to a second side of the vertical skirt wall, the pin support frame defining a cylindrical pin bore concentric therewith and opening to the first side of the vertical skirt wall and the second side of the vertical skirt wall, the pin support frame defining a rod connection opening between the pin support bore and the void region.

4. The piston unit of claim 3, wherein the first mating surface of the crown member is welded to the second mating surface of the integrated crosshead pin support and skirt member.

5. The piston unit of claim 4, wherein the first mating surface is friction welded to the second mating surface.

6. The piston unit of claim 3, wherein the interior cylindrical member defines a cooling cavity therein and wherein the interior cylindrical member further defines a plurality of oil jet openings passing therethrough so that the cooling cavity is in fluid communication with the ring-shaped void, each of the plurality of oil jet openings being disposed between two different struts; and wherein the disc-shaped top member of the integrated crosshead pin support and skirt member further defines a central pin oil supply passage passing through the top member so that the cooling cavity defined by the interior cylindrical member is in fluid communication with the void region of the integrated crosshead pin support and skirt member.

7. The piston unit of claim 1, wherein the crosshead piston pin is disposed within the pin bore, the crosshead piston pin having a cylindrical axis and defining an oil passage passing orthogonally to the cylindrical axis, the crosshead piston pin further defining two spaced-apart threaded holes, each disposed on a different side of the oil passage and configured to receive therein a piston rod coupling bolt.

8. The piston unit of claim 7, wherein the crosshead piston pin includes an outer surface and comprises a diamond-like carbon coating affixed to a portion of the outer surface.

9. A crosshead piston including a crosshead piston unit consisting essentially of forged steel.

10. The crosshead piston of claim 9, wherein the crosshead piston unit comprises:
(a) a piston crown member; and
(b) a crosshead pin support member affixed to the piston crown member and configured to support a crosshead piston pin.

11. The crosshead piston of claim 10, further comprising a skirt member that is integrated with the crosshead pin support and that consists essentially of forged steel.

12. The crosshead piston of claim 10, wherein the piston crown member comprises:
(a) a cylindrical piston ring carrying member, including an exterior vertical wall and a top portion, the top portion having an interior side and an opposite exterior side;
(b) a compression bowl defined by the exterior side of the top portion;
(c) an interior cylindrical member extending downwardly from the interior side of the top portion and defining a ring-shaped void between interior cylindrical member and the vertical wall, the interior cylindrical member terminating in a first mating surface; and
(d) a plurality of evenly spaced-apart struts extending radially from the interior cylindrical member and the vertical wall, the plurality of struts integral with the cylindrical member, the exterior wall and the top portion.

13. The crosshead piston of claim 12, wherein the crosshead pin support member comprises:
(a) a disc-shaped top member having a top side and an opposite bottom side;
(b) a cylindrical mating member extending upwardly from the top side of the top member and terminating in a second mating surface, the second mating surface having a shape that corresponds to the first mating surface so that the first mating surface and the second mating surface are substantially contiguous; and
(c) a pin support frame disposed within the void region and extending downwardly from the bottom side of the top member, the pin support frame defining a cylindrical pin bore concentric therewith and opening to the first side of the pin support frame and to a second side of the pin support frame, the pin support frame defining a rod connection opening downwardly.

14. The crosshead piston of claim 13, wherein the first mating surface of the crown member is welded to the second mating surface of the integrated crosshead pin support and skirt member.

15. The crosshead piston of claim 14, wherein the first mating surface is friction welded to the second mating surface.

16. The crosshead piston of claim 14, further comprising a crosshead piston pin disposed within the pin bore, the pin having a cylindrical axis and defining an oil passage passing orthogonally to the cylindrical axis, the pin further defining two spaced-apart threaded holes, each disposed on a different side of the oil passage and configured to receive therein a piston rod coupling bolt.

17. The crosshead piston of claim 16, wherein the crosshead piston pin includes an outer surface and comprises a diamond-like carbon coating on a portion of the outer surface.

18. A method of making a crosshead piston, comprising the steps of:
(a) forging a piston crown member from steel;
(b) forging an integrated crosshead pin support and skirt member from steel; and
(c) welding the piston crown member to the integrated crosshead pin support and skirt member.

19. The method of claim 18, wherein the piston crown member is forged to include a cylindrical first mating surface and the integrated crosshead pin support and skirt member is forged to include a cylindrical second mating surface, and wherein the welding step comprises the step of friction welding the first mating surface to the second mating surface.

20. The method of claim 18, wherein the piston crown member is forged to include: a cylindrical piston ring carrying member, including an exterior vertical wall and a top portion, the top portion having an interior side and an opposite exterior side; a compression bowl defined by the exterior side of the top portion; an interior cylindrical member extending downwardly from the interior side of the top portion and defining a ring-shaped void between interior cylindrical member and the vertical wall, the interior cylindrical member terminating in a first mating surface; and a plurality of evenly spaced-apart struts extending radially from the interior cylindrical member and the vertical wall, the plurality of struts integral with the cylindrical member, the exterior wall and the top portion, and wherein the integrated crosshead pin support and skirt member is forged to include: a disc-shaped top member having a top side and an opposite bottom side; a cylindrical mating member extending upwardly from the top side of the top member and terminating in a second mating surface, the second mating surface having a shape that corresponds to the first mating surface so that the first mating surface and the second mating surface are substantially contiguous; a vertical skirt wall extending downwardly from the top member, the skirt wall having a first side and a second side opposite from the first side, the vertical skirt wall and the bottom side of the top member defining a void region opening to a bottom region of the vertical skirt wall; a pin support frame disposed within the void region and extending downwardly from the bottom side of the top member, the pin support frame extending from a first side of the vertical skirt wall to a second side of the vertical skirt wall, the pin support frame defining a cylindrical pin bore concentric therewith and opening to the first side of the vertical skirt wall and the second side of the vertical skirt wall, the pin support frame defining a rod connection opening between the pin support bore and the void region, wherein the interior cylindrical member defines a cooling cavity therein,
and further comprising the step of drilling a plurality of oil jet openings passing through the interior cylindrical member so that the cooling cavity is in fluid communication with the ring-shaped void, each of the plurality of oil being drilled so as to be disposed between two different struts; and wherein the disc-shaped top member of the integrated crosshead pin support and skirt member further defines a central pin oil supply passage passing through the top member so that the cooling cavity defined by the interior cylindrical member is in fluid communication with the void region of the integrated crosshead pin support and skirt member.
